(19) United States
(12) Patent Application Publication
(10) Pub. No.: US 2026/0017216 A1
(43) Pub. Date: Jan. 15, 2026

(54) OPTIMIZATION SUPPORT DEVICE, OPTIMIZATION SUPPORT METHOD, AND NON-TRANSITORY RECORDING MEDIUM

(71) Applicant: NEC Corporation, Tokyo (JP)

(72) Inventor: So YAMADA, Tokyo (JP)

(73) Assignee: NEC Corporation, Tokyo (JP)

(21) Appl. No.: 19/245,500

(22) Filed: Jun. 23, 2025

(30) Foreign Application Priority Data
Jul. 9, 2024 (JP) 2024-110385

(51) Int. Cl. G06F 13/20

(52) U.S. Cl. CPC G06F 13/20; G06F 2213/40

(57) ABSTRACT

An optimization support device for calculating an input point according to a desired output of an objective function, wherein the objective function is a model in which relationships between functions are represented by a directed acyclic graph with functions as nodes and inputs/outputs as edges. The optimization support device includes processors configured to generate proxy models indicating prediction distributions of output values for each function, determine an input range of a child node function from an output range of a parent node function estimated based on the proxy model, select an input point within the determined input range, update the proxy model using sampled data for the selected input point, and calculate the input point according to the desired output using a prediction distribution of objective function output values calculated based on the proxy model thereby supporting decision making for optimization problems.

This application is based upon and claims the benefit of priority from Japanese Patent Application No. 2024-110385, filed on Jul. 9, 2024, the disclosure of which is incorporated herein in its entirety by reference.

### TECHNICAL FIELD

The present disclosure relates to an optimization support device, an optimization support method, and a recording medium.

### BACKGROUND ART

The gray box optimization is a method of obtaining an input that maximizes a final output while considering an intermediate output between functions in optimization of an objective function to which a plurality of black box functions is connected. “Poompol Buathong, Jiayue Wan, Samuel Daulton, Raul Astudillo, Maximilian Balandat, Peter I. Frazier, “Bayesian Optimization of Function Networks with Partial Evaluations,” arXiv: 2311.02146” discloses a gray box optimization method of obtaining an input that maximizes a final output in consideration of an intermediate output between functions for an objective function to which a plurality of functions is connected.

### SUMMARY

The technique described in “Poompol Buathong, Jiayue Wan, Samuel Daulton, Raul Astudillo, Maximilian Balandat, Peter I. Frazier, “Bayesian Optimization of Function Networks with Partial Evaluations,” arXiv: 2311.02146″ is difficult to apply to simulation of a system in which a user can operate an intermediate output in any manner since an input to a certain function is selected from an evaluated output of another function.

The present disclosure has been made in view of the above problems, and an object thereof is to provide an optimization support device and the like capable of supporting estimation of an input for obtaining a desired output of an objective function in a case where an intermediate output is capable of being operated in any manner for the objective function to which a plurality of functions is connected.

An optimization support device according to an aspect of the present disclosure, for calculating an input point according to a desired output of an objective function, wherein the objective function is a model in which a relationship between a plurality of functions is indicated by a directed acyclic graph with functions as nodes and inputs/outputs as edges, the optimization support device comprising: one or more memories storing instructions; and one or more processors configured to execute the instructions to generate, for each function, a proxy model indicating a prediction distribution of output values of the function; determine an input range of a function of a child node from an output range of a function of a parent node, the output range being estimated based on the proxy model; select an input point within the determined input range; update the proxy model using data sampled for the selected input point; and calculate the input point according to the desired output of the objective function using a prediction distribution of output values of the objective function, the prediction distribution being calculated based on the proxy model.

An optimization support method according to an aspect of the present disclosure, for calculating an input point according to a desired output of an objective function, wherein the objective function is a model in which a relationship between a plurality of functions is indicated by a directed acyclic graph with functions as nodes and inputs/outputs as edges, the optimization support method comprising, by a computer: generating, for each function, a proxy model indicating a prediction distribution of output values of the function; determining an input range of a function of a child node from an output range of a function of a parent node, the output range being estimated based on the proxy model; selecting an input point within the determined input range; updating the proxy model using data sampled for the selected input point; and calculating the input point according to the desired output of the objective function using a prediction distribution of output values of the objective function, the prediction distribution being calculated based on the proxy model.

According to an aspect of the present disclosure, a non-transitory recording medium records a program for causing a computer to function as an optimization support device for calculating an input point according to a desired output of an objective function, wherein the objective function is a model in which a relationship between a plurality of functions is indicated by a directed acyclic graph with functions as nodes and inputs/outputs as edges, the program causing the computer to execute: generating, for each function, a proxy model indicating a prediction distribution of output values of the function; determining an input range of a function of a child node from an output range of a function of a parent node, the output range being estimated based on the proxy model; selecting an input point within the determined input range; updating the proxy model using data sampled for the selected input point; and calculating the input point according to the desired output of the objective function using a prediction distribution of output values of the objective function, the prediction distribution being calculated based on the proxy model.

According to the present disclosure, it is possible to support estimation of an input for obtaining a desired output of an objective function in a case where an intermediate output can be operated in any manner for the objective function to which a plurality of functions is connected.

### BRIEF DESCRIPTION OF THE DRAWINGS

FIG. 1 is a diagram schematically illustrating an example of a structure of an objective function according to the present disclosure;

FIG. 2 is a first block diagram illustrating an example of a functional configuration of an optimization support device according to the present disclosure;

FIG. 3 is a first flowchart illustrating an example of an operation of the optimization support device according to the present disclosure;

FIG. 4 is a second block diagram illustrating an example of a functional configuration of an optimization support device according to the present disclosure;

FIG. 5 is a diagram illustrating an example of a proxy model according to the present disclosure;

FIG. 6 is a first diagram illustrating a process of determining an input range according to the present disclosure;

FIG. 7 is a second diagram illustrating a process of determining an input range according to the present disclosure;

FIG. 8 is a second flowchart illustrating an example of the operation of the optimization support device according to the present disclosure; and

FIG. 9 is a block diagram illustrating an example of a hardware configuration of a computer device that implements the optimization support device of the present disclosure.

### EXAMPLE EMBODIMENT

Hereinafter, example embodiments of the present disclosure will be described with reference to the drawings.

### First Example Embodiment

An outline of an optimization support device according to the first example embodiment will be described.

First, an example of a situation to which the optimization support device according to the present disclosure is applied will be described. The optimization support device of the present disclosure can be applied to a scene in which an input for obtaining a desired output is estimated for an objective function. The objective function may be a model to which a plurality of functions is connected. Each of the functions at this time may be a black box function.

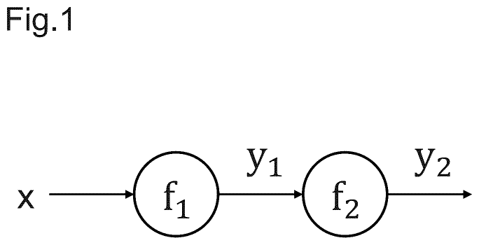

The relationship between the plurality of functions in the objective function can be indicated by a graph structure. FIG. 1 is a diagram schematically illustrating an example of a structure of an objective function. More specifically, FIG. 1 illustrates an example of a structure of an objective function of a target in the present disclosure in a graph structure. In this example, a directed acyclic graph is illustrated where the function is a node and the input/output is an edge. The function f₁and the function f₂ are connected. For example, f₁ has an input of x and an output of y₁. f₂ has an input of y₁ and an output of y₂. That is, f₂ uses the output of f₁ as an input. In this example, when f₂ is expressed as a function of a child node, f₁ is expressed as a function of a parent node.

In the example of FIG. 1, the input of the objective function is x, and the output is y₂. y₁ can be said to be an intermediate output. As described above, in the present disclosure, an example of the objective function is a model that allows a relationship between a plurality of functions to be indicated by a directed acyclic graph with a function as a node and an input/output as an edge. In the present disclosure, a model of a function indicated by the directed acyclic graph as illustrated in FIG. 1 will be mainly described as an objective function of a target, but the objective function is not limited to this example. The objective function may be a model in such a way that nodes are further connected. Alternatively, the objective function may include a function having a plurality of inputs. The objective function may further include a function having an input from the outside.

An optimization support device 100 calculates an input point related to a desired output for the objective function. For example, the optimization support device 100 calculates an input point that maximizes the output of the objective function or an input point that minimizes the output of the objective function. The desired output is not limited to this example.

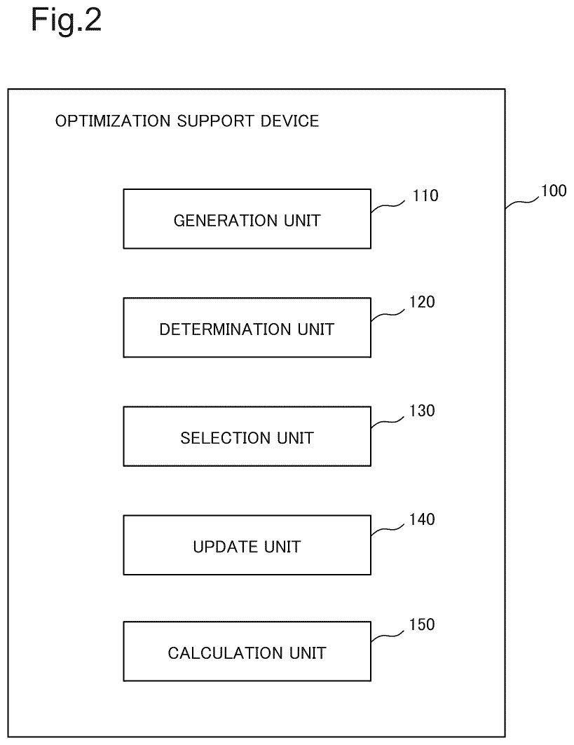

FIG. 2 is a block diagram illustrating an example of a functional configuration of the optimization support device 100 according to the first example embodiment. As illustrated in FIG. 2, the optimization support device 100 includes a generation unit 110, a determination unit 120, a selection unit 130, an update unit 140, and a calculation unit 150.

The generation unit 110 generates a proxy model. The proxy model is a model indicating a prediction distribution of the output value of the black box function. More specifically, the proxy model is a model obtained by statistically modeling the operation of the black box function configured based on sampling points. The proxy model is generated, for example, using Gaussian process regression. The proxy model may also be referred to as a surrogate model.

The generation unit 110 generates a proxy model for each of the plurality of functions included in the objective function. At this time, the generation unit 110 generates a proxy model based on the initial data. The initial data is data indicating a point sampled in advance for each function. In this manner, the generation unit 110 generates the proxy model indicating the prediction distribution of the output value of the function for each function.

The determination unit 120 determines the input range of the function. It is assumed that the output of the function of the parent node is an input to the function of the child node. At this time, the input range of the function of the child node is determined according to the output range of the function of the parent node. The output range of each function is estimated based on the proxy model. For example, the confidence interval is calculated for each function based on the proxy model. The confidence interval indicates, for a given input point of a function, an interval in which a related output point is likely to be present. For example, the determination unit 120 may determine the input range of the child node from the information about the confidence interval of the function of the parent node. The determination unit 120 may determine any input range for the function of the root node.

In this manner, the determination unit 120 determines the input range of the function of the child node from the output range of the function of the parent node, the output range being estimated based on the proxy model.

The selection unit 130 selects an input point for the function included in the objective function. The selection unit 130 selects an input point using the information of the determined input range. Specifically, for the function of which the input range has been determined, the selection unit 130 selects an input point from points within the input range. At this time, the selection unit 130 may select a point that satisfies a predetermined condition in the input range. For example, the selection unit 130 generates an acquisition function based on the proxy model. For each function, the selection unit 130 extracts a point within an input range where a value based on the acquisition function satisfies a predetermined criterion. The selection unit 130 may select one or more points among the extracted points. The method of selecting the input point is not limited to this example.

In this manner, the selection unit 130 selects an input point within the determined input range.

The function included in the objective function is sampled based on the selected input point. The update unit 140 updates the proxy model of the function using the sampled data. For example, the update unit 140 generates a proxy model using Gaussian process regression from the initial data and the data obtained by sampling for the target function the input point of which is selected. The generated proxy model is defined as a new proxy model for the target function.

In this manner, the update unit 140 updates the proxy model using the data sampled for the selected input point.

A series of processes by the determination unit 120, the selection unit 130, and the update unit 140 may be repeated a plurality of times.

The calculation unit 150 calculates an input point according to a desired output of the objective function. At this time, the calculation unit 150 uses the prediction distribution of the output value of the objective function. The prediction distribution of the output value of the objective function is calculated based on the proxy model for each function. For example, for the objective function of FIG. 1, for f₁ of the root node, the output y₁ for the input x is predicted based on the proxy model. At this time, the value of y₁ is sampled. The output y₂ of f₂ related to the sampled y₁ is predicted based on the proxy model of f₂. As a result, it is possible to calculate the prediction distribution of the output y₂ related to the input x. For example, the calculation unit 150 may calculate the acquisition function of the objective function from the prediction distribution of the output of the objective function calculated in this manner. The calculation unit 150 may calculate an input point according to a desired output of the objective function using the calculated acquisition function.

In this manner, the calculation unit 150 calculates the input point according to the desired output of the objective function using the prediction distribution of the output value of the objective function, the prediction distribution being calculated based on the proxy model.

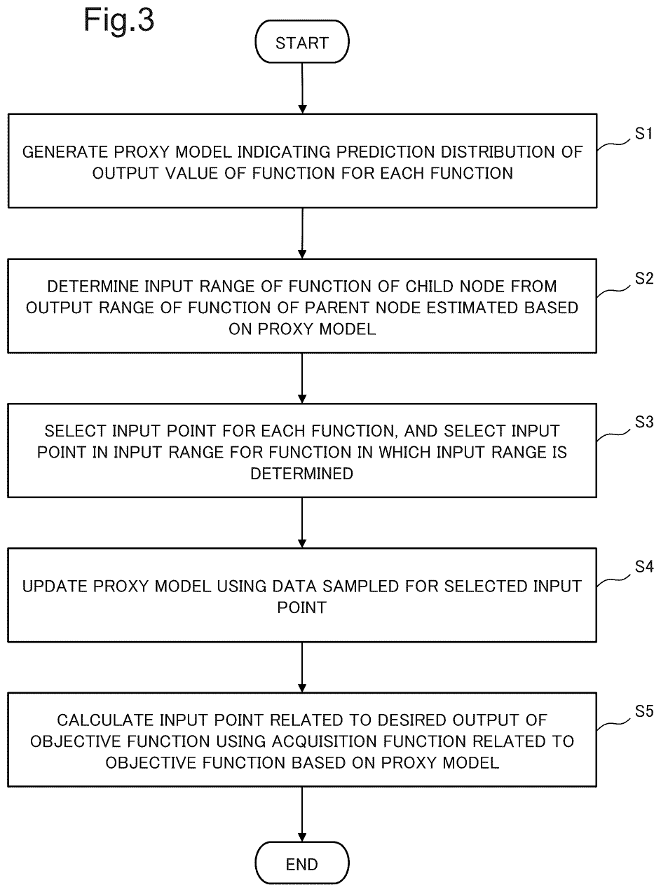

Next, an example of the operation of the optimization support device 100 will be described with reference to FIG. 3. Note that, in the present disclosure, each step of the flowchart is represented using a number assigned to each step, such as “S1”. At this time, a model that allows a relationship between a plurality of functions to be indicated by a directed acyclic graph with a function as a node and an input/output as an edge is set as an objective function.

FIG. 3 is a first flowchart for describing an example of the operation of the optimization support device 100. The generation unit 110 generates a proxy model indicating a prediction distribution of the output value of the function for each function (S1).

The determination unit 120 determines the input range of the function of the child node from the output range of the function of the parent node generated based on the proxy model (S2).

The selection unit 130 selects an input point within the determined input range (S3).

The update unit 140 updates the proxy model using the data sampled for the selected input point (S4).

The calculation unit 150 calculates the input point according to the desired output of the objective function using the prediction distribution of the output value of the objective function, the prediction distribution being calculated based on the proxy model (S5).

As described above, the optimization support device 100 of the first example embodiment generates the proxy model indicating the prediction distribution of the output value of the function for each function. Next, the optimization support device 100 determines the input range of the function of the child node from the output range of the function of the parent node generated based on the proxy model. The optimization support device 100 selects an input point within the determined input range. Further, the optimization support device 100 updates the proxy model using the data sampled for the selected input point. The optimization support device 100 calculates the input point according to the desired output of the objective function using the prediction distribution of the output value of the objective function, the prediction distribution being calculated based on the proxy model.

For a system to which a plurality of devices is connected, an optimal input for obtaining a desired output of the system is estimated by simulation. In the present disclosure, an example of a target to be regarded as an objective function is the entire system. An example of a target to be regarded as a function included in the objective function is each of input/output operations of a plurality of devices in such a system. In a situation where the optimization is performed with the simulation of the system as the objective function, the input of each function, that is, the intermediate output can be freely determined.

Assuming such simulation, the optimization support device 100 can select any input point for each function, and can perform sampling for each function included in the objective function as illustrated in the above-described configuration. Furthermore, at this time, the optimization support device 100 can perform sampling for each function in consideration of a feasible input range. In other words, the optimization support device 100 can perform sampling after appropriately excluding the intermediate output that cannot be output regardless of how to operate the input to the objective function. Therefore, the optimization support device 100 can efficiently obtain a more suitable proxy model to be used for calculating the input point according to the desired output of the objective function.

That is, the optimization support device 100 can support estimation of an input for obtaining a desired output of an objective function in a case where an intermediate output can be operated in any manner for the objective function to which a plurality of functions is connected.

### Second Example Embodiment

Next, an optimization support device according to the second example embodiment will be described. In the second example embodiment, a further example of the optimization support device 100 described in the first example embodiment will be described. Also in the present example embodiment, a model of a function indicated by the directed acyclic graph as illustrated in FIG. 1 will be mainly described as an objective function of a target. Part of the description of content overlapping with that of the first example embodiment will be omitted.

### Details of Optimization Support Device 100

In general Bayesian optimization, a proxy model is generated for an objective function that is one black box function, and an input point is searched for using various acquisition functions. Sampling is performed using the searched input point, and the proxy model is updated. As a result, an outline of the objective function is obtained.

An example of the optimization support device 100 of the present disclosure performs sampling for each function for an objective function to which a plurality of functions is connected, and calculates an input point related to a desired output for the objective function based on obtained data. For example, the optimization support device 100 generates a proxy model for each function included in the objective function. The optimization support device 100 performs sampling for each function and updates the proxy model. The optimization support device 100 repeats sampling and update of the proxy model m times (m is a natural number of one or more), and then calculates an input point according to a desired output of the objective function. The processing by the optimization support device 100 is achieved by a functional configuration described below.

In the following, as an example, an example of calculating the input x that maximizes the output y₂ of the objective function represented by the graph illustrated in FIG. 1 will be mainly described. The present disclosure is not limited to this example, and the optimization support device 100 can also be applied in a case of calculating an input that minimizes the output of the objective function.

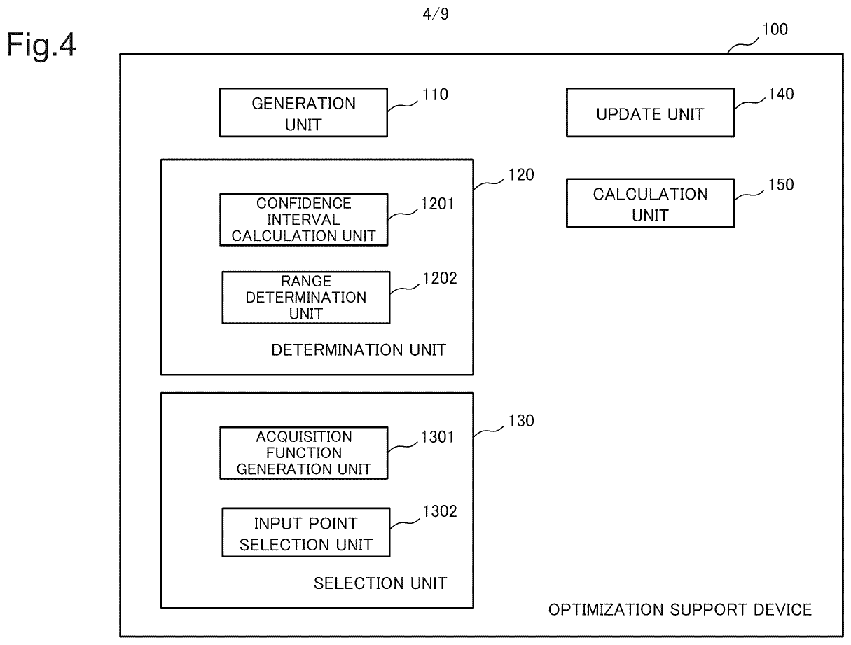

FIG. 4 is a second block diagram illustrating an example of a functional configuration of the optimization support device 100. As illustrated in FIG. 4, the optimization support device 100 includes the generation unit 110, the determination unit 120, a selection unit 130, the update unit 140, and the calculation unit 150. The optimization support device 100 may have a further configuration. For example, the optimization support device 100 may include a storage device.

The generation unit 110 generates a proxy model for each of the plurality of functions included in the objective function. That is, the generation unit 110 generates a proxy model for each of the functions f₁ and f₂. The proxy model is a model in which a prediction distribution of output values with respect to an unknown input value is expressed using an average and a variance. The proxy model based on Gaussian process regression shows a normal distribution for the function. At this time, the proxy model is represented by an average function that approximates an output value at any input point and a variance function indicating the uncertainty. The standard deviation of the prediction distribution estimated based on the variance function of the proxy model is referred to as a confidence interval.

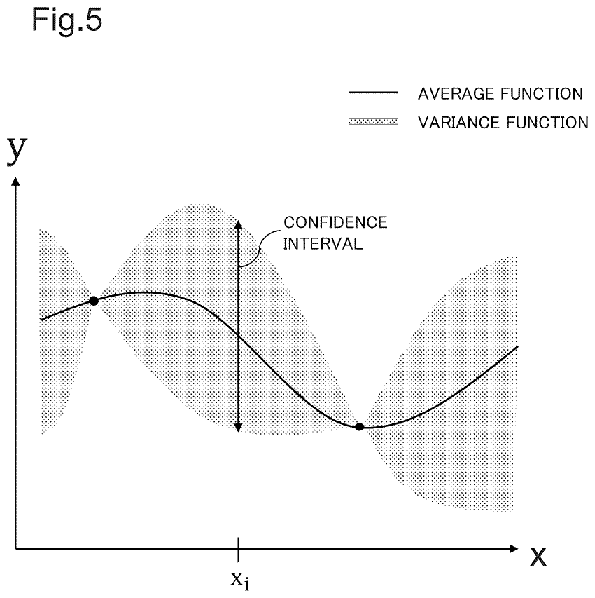

FIG. 5 is a diagram illustrating an example of a proxy model. Specifically, FIG. 5 is a diagram illustrating an image of a proxy model generated for a black box function in which the input is x and the output is y. In this example, the average function is indicated by a solid line. The range indicated by the variance function is indicated by hatching. The range indicated by this hatching is the confidence interval. For example, it is indicated that the output yᵢ related to the input xᵢ has a high probability of being present within the confidence interval indicated by the bidirectional arrow.

When there is no known data at the time of generating the proxy model, the distribution is uniform. Once the known data is added, the proxy model is generated (or updated). The generation unit 110 generates a proxy model using the initial data. The initial data indicates pre-sampled points for each function. The initial data exists for each function. The initial data includes, for each function, a set of the input point and the related output point. The initial data may be stored in, for example, a storage device (not illustrated) included in the optimization support device 100. Alternatively, the initial data may be stored in an external storage device communicably connected to the optimization support device 100.

The determination unit 120 includes a confidence interval calculation unit 1201 and a range determination unit 1202. The confidence interval calculation unit 1201 calculates the upper limit value and the lower limit value of the confidence interval of the function of The upper limit value and the lower limit value of the each node. confidence interval of the function are estimated based on a proxy model of the function. For example, the confidence interval calculation unit 1201 may calculate the upper limit value and the lower limit value of the confidence interval using upper confidence bound (UCB) and lower confidence bound (LCB). The UCB and the LCB are known as acquisition functions.

For example, for the function of the i-th node, the upper limit of the confidence interval for the input z is obtained as the following Mathematical formula 1.

$${UCB}^{( i )} ( z ) = {μ}^{( i )} ( z ) + {βσ}^{( i )} ( z ) \qquad [ Mathematical formula 1 ]$$

Similarly, for the function of the i-th node, the lower limit of the confidence interval for the input z is obtained as the following Mathematical formula 2.

$${LCB}^{( i )} ( z ) = {μ}^{( i )} ( z ) + {βσ}^{( i )} ( z ) \qquad [ Mathematical formula 2 ]$$

μ is an average function of the proxy model. σ is a variance function of the proxy model. β is a hyperparameter. β is a variable that can control which of the average function and the variance function is emphasized. In other words, the hyperparameter indicates the weight considering the variance. Mathematical formulas 1 and 2 can also be said to be models using an average and a variance based on a proxy model and a hyperparameter indicating a weight considering the variance.

This hyperparameter can be changed. For example, the larger the hyperparameter, the more the variance is emphasized. On the other hand, the smaller the hyperparameter, the more the average is emphasized. As the number of times of sampling increases, the average function of the proxy model is approximated to a true function. Therefore, the confidence interval calculation unit 1201 may decrease the value of the hyperparameter as the number of times of sampling increases, for example. As a result, the confidence interval calculation unit 1201 can calculate the upper limit value and the lower limit value of the confidence interval of the function more accurately.

As described above, the confidence interval calculation unit 1201 may calculate the upper limit value and the lower limit value of the confidence interval of the function based on the model using an average and a variance based on the proxy model and a hyperparameter indicating the weight considering the variance. The confidence interval calculation unit 1201 may change the hyperparameter according to the number of times of sampling.

The values of the UCB and the LCB can be calculated for each input value. The upper limit value of the confidence interval of the function indicates the maximum value among the values of the UCB calculated for the target function. Hereinafter, the upper limit value of the confidence interval of the function is referred to as a maximum upper limit confidence interval. The lower limit value of the confidence interval of the function indicates the minimum value among the values of the LCB calculated for the target function. Hereinafter, the lower limit value of the confidence interval of the function is referred to as a minimum lower limit confidence interval.

The range determination unit 1202 determines the input range of the child node based on the maximum upper limit confidence interval and the minimum lower limit confidence interval calculated by the confidence interval calculation unit 1201. For example, it is assumed that the range determination unit 1202 calculates the maximum upper limit confidence interval and the minimum lower limit confidence interval for the function of the i-th node. In this case, the range determination unit 1202 determines the input range of the function of the child node of the i-th node. At this time, the input range is from the minimum lower limit confidence interval to the maximum upper limit confidence interval.

The input range is Δ. An input to the root node is x. At this time, the input range of the child node when the i-th node is set as the parent node can be expressed as follows.

$${Δ}^{( i + 1 )} ( x ) = [ {min}_{x ∈ {Δ}^{( i )} ( x )} {\overline{LCB}}^{( i )} ( z ) , {max}_{x ∈ {Δ}^{( i )} ( x )} {\overline{UCB}}^{( i )} ( z ) ] \qquad [ Mathematical formula 3 ]$$

The root node is indicated as follows.

$${Δ}^{( 1 )} ( x ) = \{ x \} \qquad [ Mathematical formula 4 ]$$

In this manner, the confidence interval calculation unit 1201 calculates the upper limit value and the lower limit value of the confidence interval of the function based on the proxy model of the function of the parent node. At this time, the confidence interval calculation unit 1201 calculates the upper limit value and the lower limit value of the confidence interval of the function based on, for example, a model using an average and a variance based on a proxy model and a hyperparameter indicating a weight considering the variance. The range determination unit 1202 determines a range from the calculated upper limit value to the calculated lower limit value as an input range of the function of the child node.

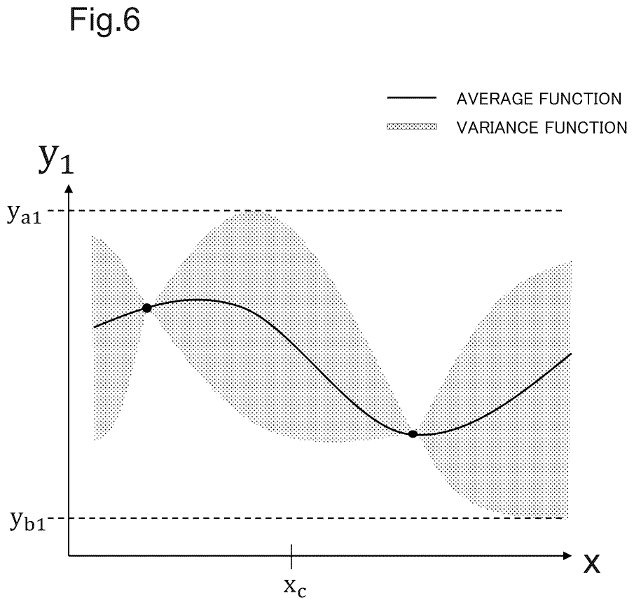

Next, a process of determining the input range will be described. It is assumed that the objective function is a function illustrated in the graph of FIG. 1. At this time, the determination unit 120 performs processing in order from the root node of the objective function. Specifically, the confidence interval calculation unit 1201 calculates the maximum upper limit confidence interval and the minimum lower limit confidence interval for the function f₁ of the root node. FIG. 6 is a first diagram describing a process of determining an input range. A proxy model of the function f₁ in which the input is x and the output is y₁ is illustrated as in FIG. 6. At this time, the maximum upper limit confidence interval is the upper limit value of the confidence interval, that is, yₐ₁. The minimum lower limit confidence interval is the lower limit value of the confidence interval, that is, y_{b1}. That is, it is found that there is a high possibility that the output value of f₁ is in the range from y_{b1} to yₐ₁.

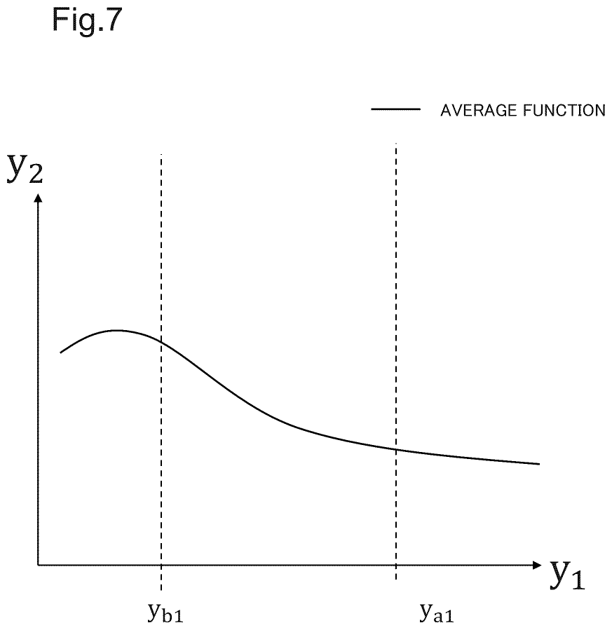

The output of f₁ is an input of f₂ which is a function of the child node. Therefore, it can be said that there is a high possibility that the input value of f₂ is in the range from y_{b1} to yₐ₁. Therefore, the range determination unit 1202 determines the input range of f₂ as y_{b1} to yₐ₁. FIG. 7 is a second diagram describing a process of determining an input range. Specifically, FIG. 7 illustrates an average function of a function f₂ in which the input is y₁ and the output is y₂. For f₂, it can be seen that search may be performed with y₁ in the range from y_{b1} to yₐ₁.

In a case where there is a child node having f₂ as a parent node, the confidence interval calculation unit 1201 calculates a maximum upper limit confidence interval and a minimum lower limit confidence interval for f₂ with y₁ in the range from y_{b1} to yₐ₁. The range determination unit 1202 determines the input range of the child node based on the calculated maximum upper limit confidence interval and the calculated minimum lower limit confidence interval regarding f₂. In this manner, the determination unit 120 determines the input range of each function included in the objective function by recursively calculating the maximum upper limit confidence interval and the minimum lower limit confidence interval from the root node.

As described above, the confidence interval calculation unit 1201 calculates the upper limit value and the lower limit value of the confidence interval of the function of the parent node from an average and a variance based on the proxy model of the function of the parent node. The range determination unit 1202 determines a range from the calculated upper limit value to the calculated lower limit value as an input range of the function of the child node.

The selection unit 130 selects an input point within the determined input range. The selection unit 130 includes an acquisition function generation unit 1301 and an input point selection unit 1302. The acquisition function generation unit 1301 first generates an acquisition function based on the proxy model for each function. At this time, the acquisition function is a function of searching for an input point, of the function, related to the output of the objective function. For example, for the function f₂, the acquisition function generation unit 1301 generates an acquisition function of searching for the input y₁ that maximizes the output y₂. As the acquisition function, various acquisition functions related to a desired output, such as probability of improvement (PI), expected improvement (EI), UCB, and LCB can be used. For example, in a case where the UCB is used, the acquisition function of f₂ is generated based on the average function and the variance function of the proxy model of f₂ as represented in Mathematical formula 1.

For the function f₁, an acquisition function is generated to search for the input x that maximizes the output y₂. The distribution of the output y₂, related to the input x, is unknown at this time. Therefore, the acquisition function generation unit 1301 approximates the distribution of y₂ related to x.

First, the acquisition function generation unit 1301 samples the output y₁ when x is input to f₁. In the Gaussian process regression, y₁ related to x is estimated to exist according to the following Gaussian distribution.

$$N ( μ ( x ) , {σ}^{2} ( x ) ) \qquad [ Mathematical formula 5 ]$$

Therefore, the acquisition function generation unit 1301 performs sampling assuming that y₁ related to x exists with a probability related to the Gaussian distribution. For example, in FIG. 6, it is assumed that a candidate point indicating a candidate of the value of y₁ related to the input x_{c} is sampled. The value of the average function related to x_{c} is assumed to be y_{c}. The acquisition function generation unit 1301 samples a plurality of candidate points of y₁ from the confidence interval related to x_{c}. For example, the acquisition function generation unit 1301 performs sampling in such a way as to take more points as the value is closer to y_{c} among the candidate points in the confidence interval. At this time, the acquisition function generation unit 1301 may perform sampling using a random number in such a way as to acquire more points as the value is closer to y_{c}.

It is estimated that y₂ related to y₁ similarly exists according to the Gaussian distribution. Therefore, the acquisition function generation unit 1301 samples the candidate point of the value of y₂ related to y₁ using y₁ sampled for x. For example, the acquisition function generation unit 1301 acquires a point indicating a value of y₂ related to y_{c}. Through such processing, the acquisition function generation unit 1301 can acquire the value of y₂ (that is, the sampling point) related to x. The acquisition function generation unit 1301 can acquire the prediction distribution of y₂ by performing this processing for a plurality of x. It can be said that this prediction distribution approximates the distribution of y₂ related to x.

The acquisition function generation unit 1301 performs similar process on an objective function to which three or more nodes are connected. That is, the acquisition function generation unit 1301 performs a process of sampling the candidate point of the output of the function of the child node using the candidate point of the output sampled for the function of the parent node up to the function of the leaf node reachable from each function. As a result, the acquisition function generation unit 1301 calculates a prediction distribution of the output of the objective function related to the input of each function. The acquisition function generation unit 1301 generates an acquisition function for each function from the calculated prediction distribution.

The acquisition function generated for f₁ can be expressed as follows, for example. The following Mathematical formula 6 is an acquisition function generated when the prediction distribution of y₂ is applied to the UCB. At this time, the average is μ₁(x), and the variance is σ₁²(x) for f₁(x). The average is μ₂(y₁), and the variance is σ₂²(y₁) for f₂ (x).

$$α ( x ) = \frac{1}{T} {\sum }_{i}^{T} {μ}_{2}^{i} ( {y}_{1}^{i} ) + {βσ}_{2}^{2} ( {y}_{1}^{i} ) \qquad [ Mathematical formula 6 ]$$

The input point selection unit 1302 extracts a candidate of an input point in the input range according to the first criterion for each function. For example, the input point selection unit 1302 may extract, as a candidate, an input point at which the maximum value of the acquisition function is obtained for each function. On the other hand, the input point selection unit 1302 may select the input point based on a predetermined evaluation value according to the acquisition function.

It is assumed that a system that is a simulation of a trial in the presence or absence of a design industry or the like involving a trial and to which a plurality of devices is connected is regarded as an objective function. The simulation of the operation of each device is related to each function included in the objective function. The trial may incur costs. The cost is the time, cost, and the like spent for the trial. The respective devices may have different costs. Even in one device, the cost spent by the input may be different. Therefore, in order to efficiently perform sampling for each function, a candidate for an input point may be extracted based on an evaluation value in consideration of cost.

Specifically, the input point selection unit 1302 may calculate the value of the acquisition function per cost for each function. For example, it is assumed that an acquisition function α(x) is generated for f₁. At this time, the input point selection unit 1302 may calculate α(x)/cᵢ and extract an input point having the highest value of the acquisition function per cost. cᵢ is a function indicating a cost. Such information about the cost for each function is stored in advance in the storage device included in the optimization support device 100.

The input point selection unit 1302 similarly calculates the value of the acquisition function per cost for f₂. Specifically, the input point selection unit 1302 extracts an input point having the highest value of the acquisition function per cost within the determined input range.

The input point selection unit 1302 selects an input point that satisfies the second criterion among the points extracted for each function. For example, the input point selection unit 1302 selects one input point having the highest value of the acquisition function per cost among the extracted points. Not limited to this example, the input point selection unit 1302 may select a plurality of high level input points having a high value of the acquisition function per cost among the extracted points.

In this manner, the acquisition function generation unit 1301 generates the acquisition function based on the proxy model for each function. The input point selection unit 1302 extracts, for each function, an input point at which the value of the acquisition function per cost in the determined input range satisfies the first criterion based on the cost determined for the function. The input point selection unit 1302 selects an input point that satisfies the second criterion among the points extracted for each function. As a result, the optimization support device 100 can perform sampling for each function in consideration of cost.

For the function included in the objective function, sampling is performed based on the selected input point. The sampling may be performed by the update unit 140. At this point, data sampled for each node is accumulated. The accumulated data can be expressed as follows.

$${\{ {( {z}_{j , k} , {y}_{j , k} )}_{j = 1}^{{n}_{k}} \}}_{k = 1}^{K} \qquad [ Mathematical formula 7 ]$$

where z_{j,k} represents j-th input data at the node k. y_{j,k} represents j-th output data at the node k. K is the number of nodes. The data represented by Mathematical formula 7 includes initial data.

The update unit 140 generates a proxy model based on the Gaussian process regression again for each function using the initial data and the sampled data.

The optimization support device 100 may repeat a series of processing by the determination unit 120, the selection unit 130, and the update unit 140 until a predetermined condition is satisfied. An example of the predetermined condition is the number of times. For example, the optimization support device 100 may repeat a series of processing until the number of times the proxy model is updated is equal to or more than a predetermined value. An example of the predetermined condition is cost. For example, the optimization support device 100 may repeat a series of processing until the accumulated value of the cost spent for the simulation is equal to or more than a predetermined value.

The calculation unit 150 calculates an input point to the objective function according to a desired output of the objective function. When the objective function is as in the example of FIG. 1, the calculation unit 150 uses an acquisition function of searching for the input x that maximizes the output y₂. This acquisition function is similar to the acquisition function generated for the function f₁ of the root node by the acquisition function generation unit 1301. The calculation unit 150 calculates x that maximizes y₂ using the latest acquisition function of f₁.

That is, the calculation unit 150 calculates the input point according to the desired output of the objective function based on the acquisition function related to the objective function. At this time, the acquisition function related to the objective function is generated based on the prediction distribution of the output value of the objective function obtained by performing the processing of sampling the candidate point of the output of the function of the child node using the candidate point of the output sampled for the function of the parent node from the function of the root node to the function of the leaf node.

### Operation Example of Optimization Support Device 100

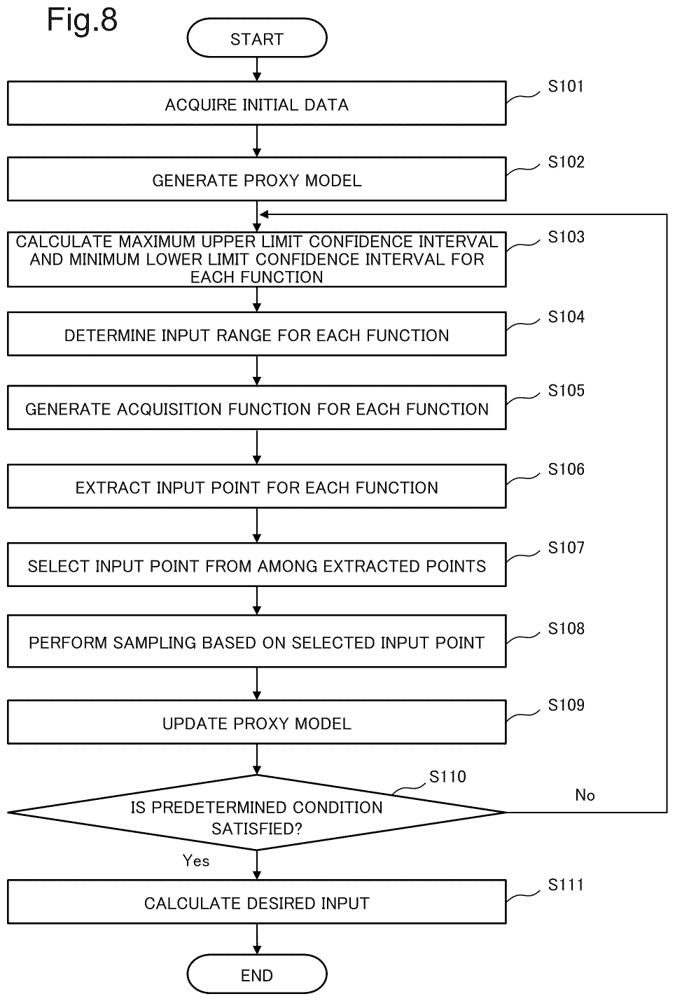

Next, an example of the operation of the optimization support device 100 will be described with reference to FIG. 8. FIG. 8 is a flowchart illustrating an example of the operation of the optimization support device 100.

First, the generation unit 110 acquires initial data (S101). The initial data is data indicating a set of an input point and a related output point for each function included in the objective function. For example, the generation unit 110 acquires the initial data from the storage device included in the optimization support device 100. At this time, the generation unit 110 may acquire data obtained by performing sampling a plurality of times for each function as initial data. The generation unit 110 generates a proxy model for each of the plurality of functions using the initial data (S102).

The confidence interval calculation unit 1201 calculates the maximum upper limit confidence interval and the minimum lower limit confidence interval for each function based on the proxy model for each function (S103). The range determination unit 1202 determines an input range for each function based on the calculated maximum upper limit confidence interval and the calculated minimum lower limit confidence interval (S104).

The acquisition function generation unit 1301 generates an acquisition function for each function based on the proxy model (S105). The input point selection unit 1302 extracts, for each function, an input point at which the value of the acquisition function per cost in the determined input range satisfies the first criterion. (S106). For example, the input point selection unit 1302 extracts, for each function, an input point, within the input range, having the largest value of the acquisition function per cost. The input point selection unit 1302 selects an input point that satisfies the second criterion among the points extracted for each function (S107). For example, the input point selection unit 1302 selects the largest input point among the extracted points.

Update unit 140 performs sampling based on the selected input point (S108). The update unit 140 updates the proxy model of the function included in the objective function using the initial data and the sampled data (S109).

When the predetermined condition is not satisfied (“No” in S110), the optimization support device 100 returns to the processing of S103. That is, the optimization support device 100 repeats the processing of S103 to S108 until the predetermined condition is satisfied. An example of the predetermined condition is the number of times of update of the proxy model.

The calculation unit 150 calculates an input point related to a desired output of the objective function (S110). This operation example is merely an example. That is, the operation of the optimization support device 100 is not limited to this example.

As described above, the optimization support device 100 of the second example embodiment generates, for each function, the proxy model indicating the prediction distribution of the output value of the function. Next, the optimization support device 100 determines the input range of the function of the child node from the output range of the function of the parent node generated based on the proxy model. The optimization support device 100 selects an input point for each function. At this time, the optimization support device 100 selects an input point within the input range for the function the input range of which is determined. Further, the optimization support device 100 updates the proxy model using the data sampled for the selected input point. The optimization support device 100 calculates the input point according to the desired output of the objective function using the prediction distribution of the output value of the objective function, the prediction distribution being calculated based on the proxy model.

For a system to which a plurality of devices is connected, an optimal input for obtaining a desired output of the system is estimated by simulation. In the present disclosure, an example of a target to be regarded as an objective function is the entire system. An example of a target to be regarded as a function included in the objective function is each of input/output operations of a plurality of devices in such a system. In a situation where the optimization is performed with the simulation of the system as the objective function, the input of each function, that is, the intermediate output can be freely determined.

Assuming such simulation, the optimization support device 100 can select any input point for each function, and can perform sampling for each function included in the objective function as illustrated in the above-described configuration. Furthermore, at this time, the optimization support device 100 can perform sampling for each function in consideration of a feasible input range. In other words, the optimization support device 100 can perform sampling after appropriately excluding the intermediate output that cannot be output regardless of how to operate the input to the objective function. Therefore, the optimization support device 100 can efficiently obtain a more suitable proxy model to be used for calculating the input point according to the desired output of the objective function.

That is, the optimization support device 100 can support estimation of an input for obtaining a desired output of an objective function in a case where an intermediate output can be operated in any manner for the objective function to which a plurality of functions is connected.

The proxy model may be a model in which a prediction distribution of output values with respect to an unknown input value is expressed using an average and a variance. The optimization support device 100 calculates the upper limit value and the lower limit value of the confidence interval of the function from an average and a variance based on the proxy model of the function of the parent node, and determines the range from the calculated upper limit value to the calculated lower limit value as the input range of the function of the child node. As described above, the optimization support device 100 can determine the input range of the function of the child node in consideration of the upper limit and the lower limit of the range of the value output by the function of the parent node.

The optimization support device 100 may generate, for each function, an acquisition function based on the proxy model, extract, for each function, an input point at which the value of the acquisition function per cost in the determined input range satisfies the first criterion based on the cost determined for the function, and select an input point satisfying the second criterion among the points extracted for each function. As a result, the optimization support device 100 can preferentially perform, for example, sampling of a function having a high value of the acquisition function per cost. As a result, the optimization support device 100 can obtain the outline of the prediction distribution of the objective function using first the function with low cost, and thus, it is possible to suppress an increase in cost spent on the entire processing.

### Modifications

The selection unit 130 selects, for each function, an input point at which the value of the acquisition function per cost satisfies a predetermined criterion from the determined input range. The information about the cost at this time may be estimated by the optimization support device 100.

As described in the operation example of the optimization support device 100, the generation unit 110 generates the proxy model for each of the plurality of functions using the initial data. The initial data may be data obtained by performing sampling a plurality of times for each function. A cost is generated in one sampling. For example, a predetermined time is spent for one sampling. Therefore, the generation unit 110 may estimate the cost for each function from the cost spent for sampling. For example, it is assumed that sampling is performed a plurality of times for the function f₁. At this time, the generation unit 110 calculates an average of the costs generated by the sampling. The generation unit 110 may estimate the calculated average cost as the cost of f₁. Information about the cost generated by each sampling is included in the initial data.

As described above, the generation unit 110 generates a proxy model for each function using the initial data indicating the cost obtained by performing sampling a plurality of times. At this time, the initial data includes a set of an input point and a related output point of each function and information indicating a cost generated for each sampling. The generation unit 110 may estimate the cost of each function from the information indicating the cost included in the initial data.

### Specific Example

The optimization support device 100 of the present disclosure can be applied to, for example, a simulation regarding design of an airplane.

Specifically, it is assumed that a simulation for outputting the fuel consumption of the airplane is performed. At this time, the simulation for outputting the fuel consumption includes the structural mechanics simulation for designing the material of the airplane and the fluid dynamics simulation for designing the shape of the wing from the information of the designed material. In this case, among the objective functions illustrated in the graph of FIG. 1, the structural mechanics simulation is a function f₁, and the fluid dynamics simulation is a function f₂.

At this time, the input x is the type, composition ratio, hardness, and the like of the material. The intermediate output y₁ indicates the material of the airplane. The output y₂ is fuel consumption.

In such a situation, by using the method of the present example embodiment, the function f₁ is executed using various kinds of x, and the function f₂ is executed using various kinds of y₁. That is, for each function, any input can be determined and evaluation can be performed for each function.

As another specific example, the optimization support device 100 of the present disclosure can also be applied to a simulation regarding a product shipping process in a factory. This simulation is implemented as a system constructed on a server, collects information about each process in a factory via a network, and calculates an optimal production plan and an optimal shipping schedule of a product.

Specifically, it is assumed that a simulation for finding an optimal process for manufacturing and shipping a product by the delivery date is performed. At this time, the simulation includes a manufacturing process simulation representing a process of manufacturing part of a product, an assembly process simulation representing a process of assembling the manufactured part, and a shipping process simulation representing a process of packaging and shipping the assembled product. In this case, among the objective functions illustrated in the graph of FIG. 1, the manufacturing process simulation is a function f₁, the assembly process simulation is a function f₂, and the shipping process simulation is a function f₃.

At this time, the input x is the type of product, the necessary number of parts, the manufacturing start date, and the like. The intermediate output y₁ indicates the type and the quantity of parts produced in the manufacturing process. The intermediate output y₂ indicates the type and the quantity of products assembled in the assembly process. The output y₃ is an evaluation value of the entire shipping process including the shipping date and the transportation cost.

Information about each process is collected from a manufacturing machine, an assembly robot, and a sensor and a camera attached to a shipping facility, and collected in a server via a network. The optimization support device 100 on the server executes a simulation while acquiring the input/output values of each function based on the aggregated information.

In such a situation, by using the method of the present example embodiment, the function f₁ is executed using the types and quantities of various products, the manufacturing start date, and the like as the input value x, or the function f₂ is executed using a combination of various manufactured parts as the input value y₁. That is, for each step, any input can be determined and evaluation can be performed for each function. As a result, even when the type, quantity, and delivery date of the product are changed, a new production plan and a new shipping schedule can be quickly calculated.

As described above, by using the optimization support device 100 mounted on the server, it is possible to simulate and optimize the entire product shipping process while collecting information in the factory.

This specific example illustrates an example of a situation where the optimization support device 100 is applied. The situation where the optimization support device 100 is applied is not limited to this example.

### Configuration Example of Hardware of Optimization Support Device

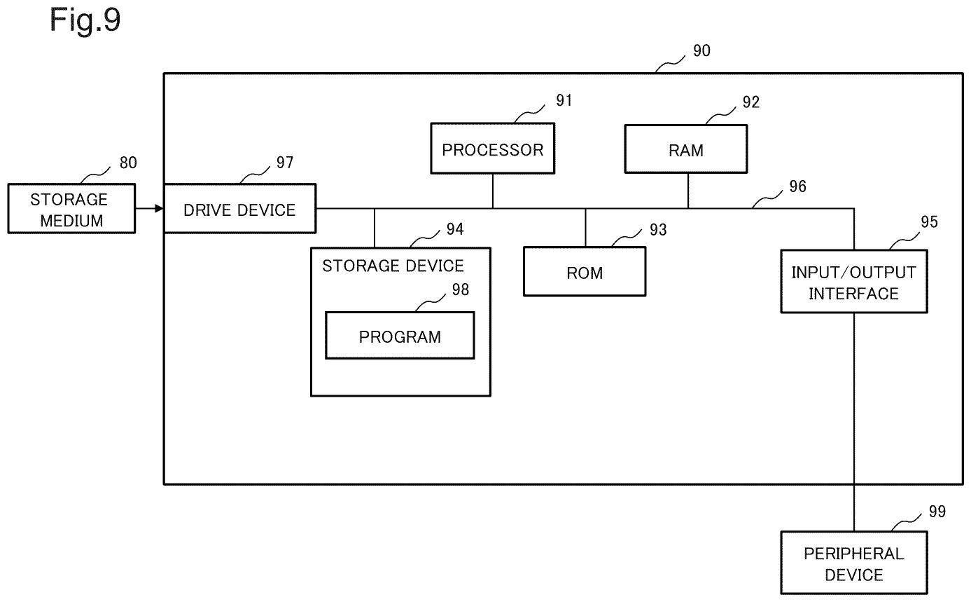

Hardware constituting the optimization support devices of the first and the second example embodiments will be described. FIG. 9 is a block diagram illustrating an example of a hardware configuration of a computer device constituting the optimization support device according to each example embodiment. In a computer device 90, the optimization support device and the optimization support method described in each example embodiment and each modification are achieved. For example, the optimization support device and the like described in each example embodiment and each modification may have the hardware configuration illustrated in FIG. 9.

As illustrated in FIG. 9, the computer device 90 includes a processor 91, a random access memory (RAM) 92, a read only memory (ROM) 93, a storage device 94, an input/output interface 95, a bus 96, and a drive device 97. The optimization support device and the like may be achieved by a plurality of electric circuits.

The storage device 94 stores a program (computer program) 98. The processor 91 executes a program 98 of the reception support system using the RAM 92. Specifically, for example, the program 98 includes a program that causes a computer to execute the processing illustrated in FIGS. 3 and 8. When the processor 91 executes the program 98, the function of each configuration of the optimization support device is implemented. The program 98 may be stored in the ROM 93. The program 98 may be recorded in a storage medium 80 and read using a drive device 97, or may be transmitted from an external device (not illustrated) to the computer device 90 via a network (not illustrated).

The input/output interface 95 exchanges data with a peripheral device (keyboard, mouse, display device, etc.) 99. The input/output interface 95 functions as a means for acquiring or outputting data. The bus 96 connects the respective components.

There are various modifications of the method of achieving the optimization support device. For example, each configuration included in the optimization support device can be achieved as a dedicated device. The optimization support device can be achieved based on a combination of a plurality of devices.

A processing method of causing a storage medium to record a program for achieving each configuration in the functions of each example embodiment, reading the program recorded in the storage medium as a code, and a computer executing the program are also included in the scope of each example embodiment. That is, a computer-readable storage medium is included in the scope of each example embodiment. A storage medium recording the above-described program and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. In addition, the program recorded in the storage medium is not limited to a program that executes processing by itself, and programs that operate on an operating system (OS) to execute processing in cooperation with other software and functions of an extension board are also included in the scope of each example embodiment.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

The above-described example embodiments and modifications can be appropriately combined.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

### SUPPLEMENTARY NOTE

Some or all of the above example embodiments may be described as the following Supplementary Notes, but are not limited to the following.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Furthermore, some or all of the configurations described as a Supplementary Note can be similarly dependent on various recording means or systems for recording various hardware, software, and software without departing from the above-described embodiments.

### Supplementary Note 1

An optimization support device for calculating an input point according to a desired output of an objective function, wherein the objective function is a model in which a relationship between a plurality of functions is indicated by a directed acyclic graph with functions as nodes and inputs/outputs as edges, the optimization support device including:
one or more memories storing instructions; and
one or more processors configured to execute the instructions to:
generate, for each function, a proxy model indicating a prediction distribution of output values of the function;
determine an input range of a function of a child node from an output range of a function of a parent node, the output range being estimated based on the proxy model;
select an input point within the determined input range;
update the proxy model using data sampled for the selected input point; and
calculate the input point according to the desired output of the objective function using a prediction distribution of output values of the objective function, the prediction distribution being calculated based on the proxy model.

### Supplementary Note 2

The optimization support device according to Supplementary Note 1, wherein
the proxy model is a model in which a prediction distribution of output values with respect to an unknown input value is expressed using an average and a variance, and
the one or more processors are further configured to execute the instructions to calculate an upper limit value and a lower limit value of a confidence interval of the function from an average and a variance of a function of a parent node based on the proxy model, and determine a range from the calculated upper limit value to the calculated lower limit value as an input range of a function of a child node.

### Supplementary Note 3

The optimization support device according to Supplementary Note 2, wherein
the one or more processors are further configured to execute the instructions to:
calculate an upper limit value and a lower limit value of a confidence interval of a function based on a model that uses an average and a variance derived from the proxy model, and a hyperparameter that indicates a weight considering the variance; and change the hyperparameter according to the number of times of sampling.

### Supplementary Note 4

The optimization support device according to Supplementary Note 1, wherein
the one or more processors are further configured to execute the instructions to calculate an input point according to a desired output of the objective function based on an acquisition function related to the objective function, the acquisition function being generated based on a prediction distribution of output values of the objective function, the prediction distribution being obtained by performing a process of sampling a candidate point of an output of a function of a child node from a function of a root node to a function of a leaf node using a candidate point of an output sampled for a function of a parent node.

### Supplementary Note 5

The optimization support device according to Supplementary Note 1, wherein
the one or more processors are further configured to execute the instructions to:
generate, for each function, an acquisition function based on the proxy model;
extract, for each function, based on a cost determined for the function, an input point at which a value of the acquisition function per cost in the determined input range satisfies a first criterion; and
select an input point that satisfies a second criterion from among the extracted points for respective functions.

### Supplementary Note 6

The optimization support device according to Supplementary Note 5, wherein
the one or more processors are further configured to execute the instructions to:
calculate a prediction distribution of an output of the objective function related to an input of each function by performing a process of sampling a candidate point of an output of a function of a child node up to a function of a leaf node reachable from each function using a candidate point of an output sampled for a function of a parent node; and
generate an acquisition function from the calculated prediction distribution.

### Supplementary Note 7

The optimization support device according to Supplementary Note 5 or 6, wherein
the one or more processors are further configured to execute the instructions to:
generate the proxy model for each function using initial data obtained by performing sampling a plurality of times for each function, the initial data include a set of an input point and a related output point of each function and information indicating a cost generated for each sampling; and
estimate a cost of each function from information indicating the cost included in the initial data.

### Supplementary Note 8

The optimization support device according to Supplementary Note 1, wherein
the one or more processors are further configured to execute the instructions to repeat the determining of the input range, the selecting of the input point, and the updating of the proxy model until a predetermined condition is satisfied.

### Supplementary Note 9

An optimization support method for calculating an input point according to a desired output of an objective function, wherein the objective function is a model in which a relationship between a plurality of functions is indicated by a directed acyclic graph with functions as nodes and inputs/outputs as edges, the optimization support method including:
by a computer,
generating, for each function, a proxy model indicating a prediction distribution of output values of the function;
determining an input range of a function of a child node from an output range of a function of a parent node, the output range being estimated based on the proxy model;
selecting an input point within the determined input range;
updating the proxy model using data sampled for the selected input point; and
calculating the input point according to the desired output of the objective function using a prediction distribution of output values of the objective function, the prediction distribution being calculated based on the proxy model.

### Supplementary Note 10

A non-transitory recording medium that records a program for causing a computer to function as an optimization support device for calculating an input point according to a desired output of an objective function, wherein the objective function is a model in which a relationship between a plurality of functions is indicated by a directed acyclic graph with functions as nodes and inputs/outputs as edges, the program causing the computer to execute:
generating, for each function, a proxy model indicating a prediction distribution of output values of the function;
determining an input range of a function of a child node from an output range of a function of a parent node, the output range being estimated based on the proxy model;
selecting an input point within the determined input range;
updating the proxy model using data sampled for the selected input point; and
calculating the input point according to a desired output of the objective function using a prediction distribution of output values of the objective function, the prediction distribution being calculated based on the proxy model.

1. An optimization support device for calculating an input point according to a desired output of an objective function, wherein the objective function is a model in which a relationship between a plurality of functions is indicated by a directed acyclic graph with functions as nodes and inputs/outputs as edges, the optimization support device comprising:
one or more memories storing instructions; and
one or more processors configured to execute the instructions to:
generate, for each function, a proxy model indicating a prediction distribution of output values of the function;
determine an input range of a function of a child node from an output range of a function of a parent node, the output range being estimated based on the proxy model;
select an input point within the determined input range;
update the proxy model using data sampled for the selected input point; and
calculate the input point according to the desired output of the objective function using a prediction distribution of output values of the objective function, the prediction distribution being calculated based on the proxy model.

2. The optimization support device according to claim 1, wherein
the proxy model is a model in which a prediction distribution of output values with respect to an unknown input value is expressed using an average and a variance, and
the one or more processors are further configured to execute the instructions to calculate an upper limit value and a lower limit value of a confidence interval of the function from an average and a variance of a function of a parent node based on the proxy model, and determine a range from the calculated upper limit value to the calculated lower limit value as an input range of a function of a child node.

3. The optimization support device according to claim 2, wherein
the one or more processors are further configured to execute the instructions to:
calculate an upper limit value and a lower limit value of a confidence interval of a function based on a model that uses an average and a variance derived from the proxy model, and a hyperparameter that indicates a weight considering the variance; and change the hyperparameter according to the number of times of sampling.

4. The optimization support device according to claim 1, wherein
the one or more processors are further configured to execute the instructions to calculate an input point according to a desired output of the objective function based on an acquisition function related to the objective function, the acquisition function being generated based on a prediction distribution of output values of the objective function, the prediction distribution being obtained by performing a process of sampling a candidate point of an output of a function of a child node from a function of a root node to a function of a leaf node using a candidate point of an output sampled for a function of a parent node.

5. The optimization support device according to claim 1, wherein
the one or more processors are further configured to execute the instructions to:
generate, for each function, an acquisition function based on the proxy model;
extract, for each function, based on a cost determined for the function, an input point at which a value of the acquisition function per cost in the determined input range satisfies a first criterion; and
select an input point that satisfies a second criterion from among the extracted points for respective functions.

6. The optimization support device according to claim 5, wherein
the one or more processors are further configured to execute the instructions to:
calculate a prediction distribution of an output of the objective function related to an input of each function by performing a process of sampling a candidate point of an output of a function of a child node up to a function of a leaf node reachable from each function using a candidate point of an output sampled for a function of a parent node; and
generate an acquisition function from the calculated prediction distribution.

7. The optimization support device according to claim 5, wherein
the one or more processors are further configured to execute the instructions to:
generate the proxy model for each function using initial data obtained by performing sampling a plurality of times for each function, the initial data include a set of an input point and a related output point of each function and information indicating a cost generated for each sampling; and
estimate a cost of each function from information indicating the cost included in the initial data.

8. The optimization support device according to claim 1, wherein
the one or more processors are further configured to execute the instructions to repeat the determining of the input range, the selecting of the input point, and the updating of the proxy model until a predetermined condition is satisfied.

9. An optimization support method for calculating an input point according to a desired output of an objective function, wherein the objective function is a model in which a relationship between a plurality of functions is indicated by a directed acyclic graph with functions as nodes and inputs/outputs as edges, the optimization support method comprising:
by a computer,
generating, for each function, a proxy model indicating a prediction distribution of output values of the function;
determining an input range of a function of a child node from an output range of a function of a parent node, the output range being estimated based on the proxy model;
selecting an input point within the determined input range;
updating the proxy model using data sampled for the selected input point; and
calculating the input point according to the desired output of the objective function using a prediction distribution of output values of the objective function, the prediction distribution being calculated based on the proxy model.

10. A non-transitory recording medium that records a program for causing a computer to function as an optimization support device for calculating an input point according to a desired output of an objective function, wherein the objective function is a model in which a relationship between a plurality of functions is indicated by a directed acyclic graph with functions as nodes and inputs/outputs as edges, the program causing the computer to execute:
generating, for each function, a proxy model indicating a prediction distribution of output values of the function;
determining an input range of a function of a child node from an output range of a function of a parent node, the output range being estimated based on the proxy model;
selecting an input point within the determined input range;
updating the proxy model using data sampled for the selected input point; and
calculating the input point according to a desired output of the objective function using a prediction distribution of output values of the objective function, the prediction distribution being calculated based on the proxy model.
